(19) United States
(12) Patent Application Publication
(10) Pub. No.: US 2025/0045737 A1
(43) Pub. Date: Feb. 6, 2025

(54) SYSTEMS AND METHODS FOR GENERATING DYNAMIC CREDIT INFORMATION

(71) Applicant: Capital One Services, LLC, McLean, VA (US)

(72) Inventors: Jeffrey RULE, Chevy Chase, MD (US); Kaitlin NEWMAN, Washington, DC (US); Jeffrey Carlyle WIEKER, Falls Church, VA (US)

(73) Assignee: Capital One Services, LLC, McLean, VA (US)

(21) Appl. No.: 18/362,713

(22) Filed: Jul. 31, 2023

(51) Int. Cl. G06Q 20/36; G06Q 20/38; G06Q 20/40

(52) U.S. Cl. CPC G06Q 20/3676; G06Q 20/389; G06Q 20/4014

(57) ABSTRACT

A method for providing in-context information is disclosed. The method includes receiving a request for in-context information, establishing a connection between the integration system and one or more user accounts, determining a user verification level, requesting user-specific data associated with the one or more user accounts upon determining the user verification level, and causing to display the in-context information via a user interface.

### TECHNICAL FIELD

Various embodiments of this disclosure relate generally to providing in-context information and, more particularly, to systems and methods for obtaining and displaying user-specific in-context information based on a determined user verification level.

### BACKGROUND

Online shopping has become a ubiquitous method for obtaining goods. Individuals often spend a large amount of time and money conducting online shopping, often without full cognizance of the impact that shopping may have on their financial status. While in-store shopping often involves cash transactions, meaning individuals may be more aware of the amount of money being spent, online shopping is almost always based on credit or debit cards. This intangible exchange of money often results in dissonance between an individual's believed ability to pay and the individual's actual financial status. Without a way to effectively visualize the impact a purchase may have on an individual's finances, the individual may conduct a purchase that may have significant financial repercussions for years.

This disclosure is directed to addressing the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for providing in-context information.

In one aspect, a method for providing in-context information is disclosed. The method may include receiving a request for in-context information, the request generated by an integration system in response to a trigger event at a user interface, wherein: the trigger event is any of a selection made by a user via an input device, a focus area selected by a user via an input device, or initiation of a web browser; the in-context information includes user-specific data; establishing a connection between the integration system and one or more user accounts; determining a user verification level, wherein the user verification level is determined using one or more authentication methods; upon determining the user verification level, requesting user-specific data associated with the one or more user accounts, the requested user-specific data indicative of the determined user verification level; and causing to display the in-context information via a user interface, the displayed in-context information determined based on the determined user verification level.

In another aspect, a method for providing in-context information is disclosed. The method may include receiving a request for in-context information, the request generated by an integration system in response to a trigger event at a user interface; establishing a connection between the integration system and one or more user accounts; determining a user verification level, wherein the user verification level is determined using one or more authentication methods; upon determining the user verification level, requesting user-specific data associated with the one or more user accounts, the requested data indicative of the determined user verification level; and causing to display the in-context information via a user interface, the displayed in-context information determined based on the determined user verification level.

In another aspect, a system is disclosed. The system may include at least one memory storing instructions; and at least one processor executing the instructions to perform operations for providing in-context information, the operations including: receiving a request for in-context information, the request generated by an integration system in response to a trigger event at a user interface, wherein: the trigger event is any of a selection made by a user via an input device, a focus area selected by a user via an input device, or initiation of a web browser; the in-context information includes user-specific data; establishing a connection between the integration system and one or more user accounts; determining a user verification level, wherein the user verification level is determined using one or more authentication methods; upon determining the user verification level, requesting data associated with the one or more user accounts, the requested data indicative of the determined user verification level; and causing to display the in-context information via a user interface, the displayed in-context information determined based on the determined user verification level.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for providing in-context information, according to one or more embodiments.

FIG. 2 depicts an exemplary method for providing in-context information, according to one or more embodiments.

FIGS. 3A-3D depict an exemplary webpage and browser plug-in for providing in-context information, according to one or more embodiments.

FIGS. 4A-4B depict exemplary webpage and application programming interface for providing in-context information, according to one or more embodiments.

FIG. 5 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In an exemplary use case, a user may utilize a browser plug-in for providing in-context information and/or in-context data, e.g., data to inform the user of the effect of a given purchase. The user may initiate a request for the in-context information by any suitable means, for example, by hovering a mouse cursor over the image of a particular item on an item detail page. The user may be prompted to provide authentication information in response to the request for in-context information. The authentication method requested may depend on the information that is being requested, such that more sensitive data (e.g., a current credit balance) may require a higher authentication, and less sensitive data (e.g., publicly-available information about a credit card interest rate) may require a lower authentication level. If authentication to a required level is successful, the requested in-context information may be displayed. If authentication is unsuccessful, a second authentication may be attempted and/or non-sensitive data (e.g., the total cost of an item after taxes and shipping) may be displayed. The user may be able to customize a window to show certain data, show the data in a certain manner, require a certain authentication, etc.

While the examples above involve providing in-context information via a browser plug-in wherein information, e.g., data, is retrieved based on a multi-tier authentication system, it should be understood that techniques according to this disclosure may be adapted to any suitable integration system and/or any suitable authentication method. It should also be understood that the examples above are illustrative only. The techniques and technologies of this disclosure may be adapted to any suitable activity. Presented below are various systems and methods of providing in-context information.

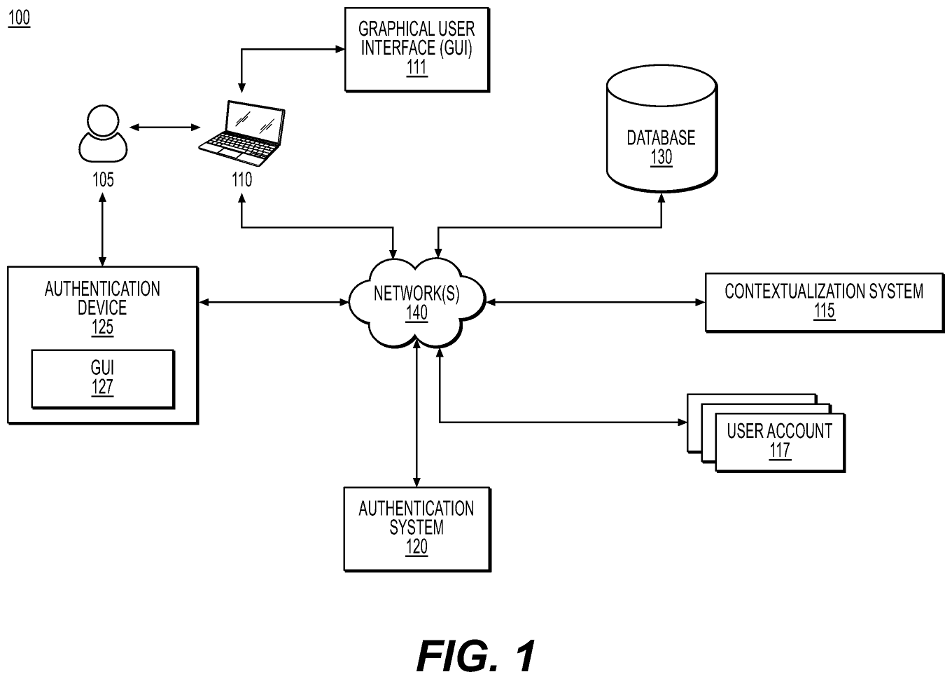

FIG. 1 depicts an exemplary environment 100 for providing in-context information, according to one or more embodiments. Environment 100 may include one or more aspects that may communicate with each other over a network 140. In some embodiments, a user 105 may interact with a user device 110 such that a request for in-context information is generated. A contextualization system 115 may be configured as an integration system to facilitate communication between and among various aspects of environment 100, such as directing an authentication system 120 to request user authorization based on the interaction of user 105 with user device 110 and/or obtaining data from one or more user accounts 117 based on feedback from authentication system 120. Authentication system 120 may be configured to interact with an authentication device 125, e.g., a cellular phone, a laptop, etc., to facilitate authentication of user 105. The one or more user accounts 117 may be any suitable account, e.g., a checking account, a savings account, a credit account, a credit score account, a financial profile, etc. In some embodiments, the one or more user accounts 117 may be associated with a financial services entity. Data obtained from the one or more aspects of environment 100 may be stored in a database 130, which may include a third party database, an internal database, etc. As used below, and for clarity, the phrase “information request” may include a request for user-specific in-context information, the phrase “verification request” may include a request to determine a user verification level, and the phrase “authentication request” may include a request for user identity-authenticating data.

User device 110 may be any suitable device, e.g., a cellular phone, a personal computer, a tablet, etc. A graphical user interface (GUI) may be displayed via user device 110 (hereinafter “GUI 111”). User device 110 may be configured to generate an information request, e.g., a request for in-context information. In-context information may be user-specific and may include any information relevant to a user, e.g., amount of money in one or more accounts (e.g., in debit accounts), available credit, credit card interest rates, total debt across all of a user's credit cards, number and/or amount owed based on third party repayment systems, a user's past payment history, how long a purchase may take to pay off based on certain variables, how much total interest may be paid on a purchase based on certain variables, how much total interest may be paid on a total account balance after a purchase based on certain variables, interactions with a given retailer (e.g., prior transactions with the retailer, prior returns to the retailer, etc.), interactions with similar classes of retailers (e.g., transactions with clothing retailers, grocery retailers, food retailers, etc.), etc.

The information request may be generated by any suitable means, e.g., using a browser plug-in, an application programming interface (API), an embedded browser, etc.). User device 110 may be configured to generate the information request in response to a user input, e.g., a cursor hovering over an icon, selecting a certain item or link, adding an item to a virtual shopping cart, initiating a webpage, downloading a browser plug-in, initiating a browser plug-in, etc. In some embodiments, the user input may be at a focus area, e.g., a shopping cart icon, an “Add-to-Cart” icon, etc. For example, user device 110 may automatically or manually generate and/or communicate the information request to another aspect of environment 100, e.g., to contextualization system 115, in response to user 105 hovering over or selecting an “Add to Cart” icon. User device 110 may be configured to communicate the information request to any suitable aspect of environment 100, e.g., to contextualization system 115, to authentication system 120, etc.

User device 110 may be configured to output a window, e.g., a window displaying the in-context information. As further described below, user device 110 may be configured to generate one or more windows, such as an information window, an embedded context window, etc. User device 110 may obtain in-context information from one or more aspects of environment 100, e.g., contextualization system 115, authentication system 120, database 130, etc. As described in further detail below, the window may be customized and/or modified, e.g., by user 105. In some embodiments, the window may include recommendations, e.g., based on the in-context information. The recommendations may include one or more of whether or not a purchase is recommended, which bank card to use for a purchase, which bank card(s) to sign up for given a user's transaction history, certain lifestyle suggestions (e.g., to reduce the frequency of purchasing clothes, to reduce the frequency of eating at restaurants, etc.), etc.

Contextualization system 115 may be configured to facilitate communication between various aspects of environment 100. In some embodiments, contextualization system 115 may include an integration system. The integration system may be configured to combine and/or connect multiple software systems, applications, and/or modules into a coherent and/or unified system. Any suitable configuration of integration may be configured. For example, contextualization system 115 may be configured to integrate with one or more aspects of environment 100, e.g., one or more user accounts 117, authentication system 120, and/or database 130. Integration may be configured to operate via any suitable means, for example, as a browser plug-in, an API, an embedded browser, etc.

In some embodiments, contextualization system 115 may be configured to receive an information request, e.g., a request for in-context information. The information request may be received from any suitable aspect of environment 100, e.g., from user device 110. As discussed herein, the information request may be generated in response to user 105 interacting with GUI 111. In some embodiments, contextualization system 115 may be configured to generate a verification request, e.g., a request to determine a user verification level. For example, contextualization system 115 may generate a verification request based on receiving an information request. Contextualization system 115 may communicate the verification request to any suitable aspect of environment 100, e.g., to authentication system 120. As described in further detail below, authentication system 120 may be configured to determine a user verification level and communicate the determined user verification level to contextualization system 115.

Contextualization system 115 may be configured to obtain a user verification level from any suitable aspect of environment 100, e.g., authentication system 120, authentication device 125, etc. Based on the determined user verification level, contextualization system 115 may be configured to obtain in-context information. For example, contextualization system 115 may obtain more sensitive user data if a high user verification level is determined, or less sensitive user data is a low user verification level is determined. As explained in further detail below, the user verification level may be determined based on the method in which a user provides identity verification. Further, the user verification level may determine the type, amount, and/or format of data requested, e.g., from the one or more user accounts 117. As further explained herein, contextualization system 115 may communicate the contextualized data to any suitable aspect of environment 100, e.g., for display by user device 110 via GUI 111.

In some embodiments, contextualization system 115 may be configured to generate the user verification level, e.g., based on data received from other aspects of environment 100. For example, contextualization system 115 may receive user identity-authenticating data from authentication device 125 and generate the user verification level therefrom. An exemplary method for determining a user verification level is described below.

Authentication system 120 may be configured to authenticate a user's identity and/or determine a user verification level. In some embodiments, authentication system 120 may be configured to determine a user's verification level, e.g., based on the authentication method used. As discussed in further detail below, authentication system 120 may be configured to use any suitable authentication method. An exemplary method for determining a user verification level is discussed in more detail below.

Authentication system 120 may be configured to receive a verification request from any suitable aspect of environment 100, e.g., from contextualization system 115. Authentication system 120 may generate an authentication request, e.g., a request for user identity-authenticating data. In some embodiments, authentication system 120 may generate an authentication request in response to the verification request. Authentication system 120 may be configured to generate the authentication request automatically or manually.

Authentication system 120 may be configured to communicate the authentication request to any suitable aspect of environment 100, e.g., contextualization system 115, authentication device 125, etc. For example, authentication system 120 may communicate the authentication request to authentication device 125. A graphical user interface (GUI) may be displayed via authentication device 125 (hereinafter “GUI 127”). Authentication device 125 may be any suitable device configured to cause to output, e.g., via GUI 127, a request for the user to provide user identity-authenticating data. For example, authentication device 125 may be a cellular phone, a tablet, a laptop, a smart watch, etc. In some embodiments, user device 110 may include authentication device 125 such that user device 110 may be configured to initiate generation of the information request and/or authenticate the identity of user 105.

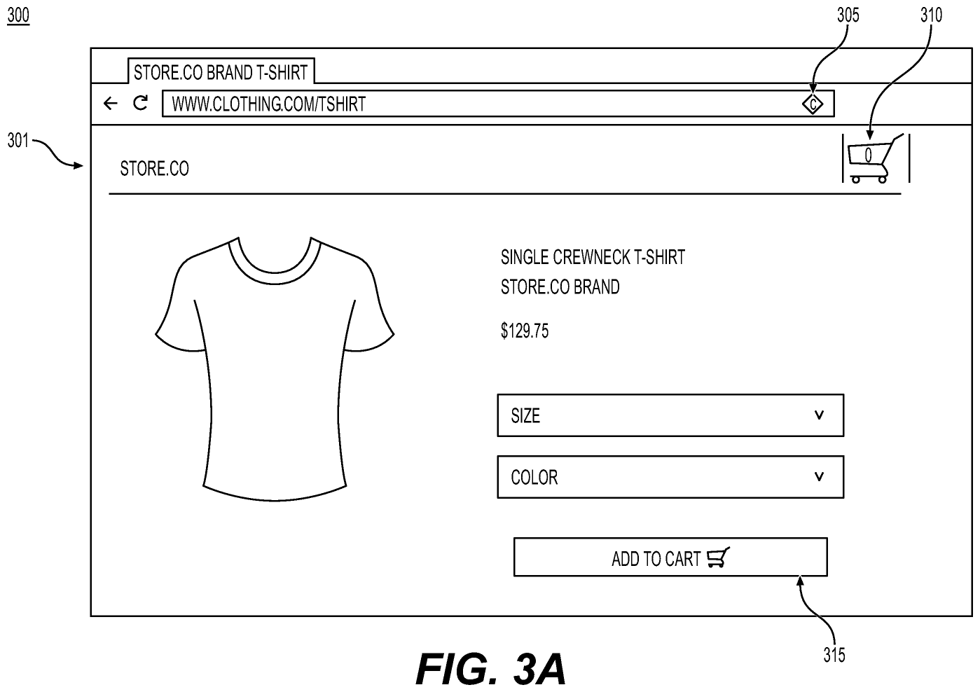

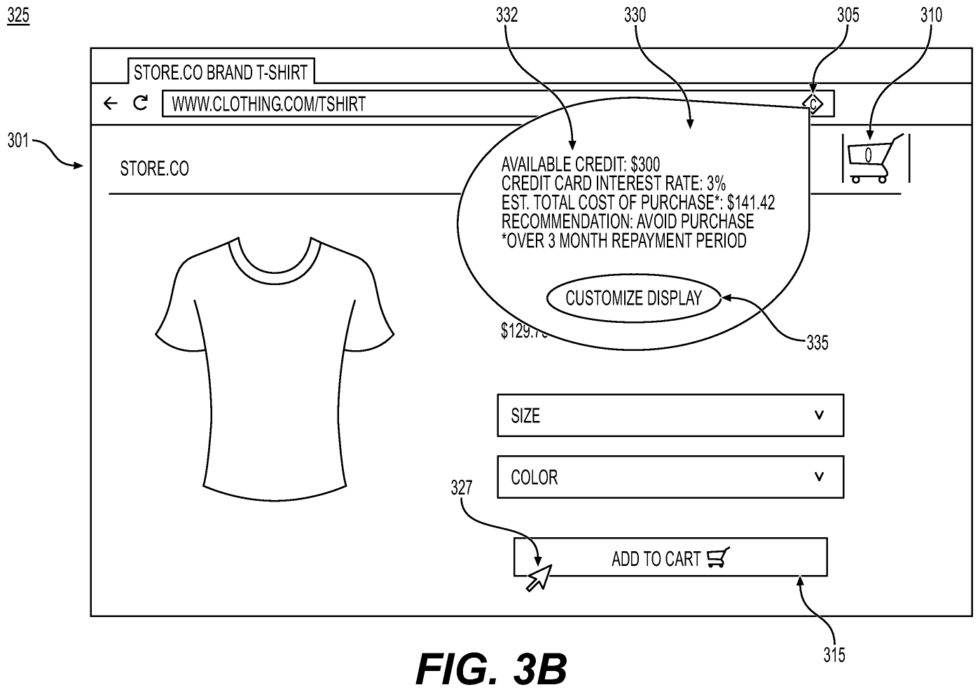

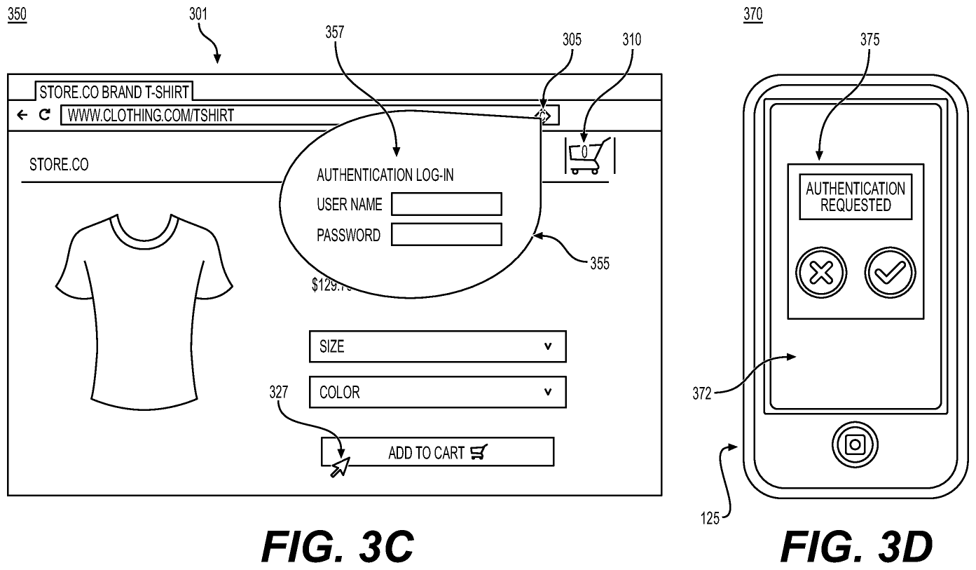

In some embodiments, user 105 may enter user identity-authenticating data, e.g., via GUI 127. For example, as described in the discussion of FIG. 3B below, authentication device 125 may output a multi-factor authentication confirmation request via GUI 127. User 105 may confirm or reject the multi-factor authentication confirmation request, e.g., via one or more user inputs at GUI 127. Authentication device 125 may communicate the user identity-authenticating data to any suitable aspect of environment 100, e.g., contextualization system 115 and/or authentication system 120.

Authentication system 120 may be configured to generate a user authentication level. In some embodiments, authentication system 120 may be configured to generate a user authentication level based on data and/or metadata obtained from one or more aspects of environment 100, e.g., user device 110, contextualization system 115, authentication device 125, database 130, etc. The data and/or metadata that may be used in generating the user authentication level may include user identity-authenticating data, type, format, method, etc. of authentication used, the security of the authentication method used, etc. For example, authentication system 120 may generate a user authentication level based on user identity-authenticating data received from authentication device 125 and/or metadata on the authentication method used from contextualization system 115. Authentication system 120 may be configured to communicate the user authentication level to one or more aspects of environment 100, e.g., contextualization system 115, database 130, etc.

One or more of the components in FIG. 1 may communicate with each other and/or other systems, e.g., across network 140. In some embodiments, network 140 may connect one or more components of environment 100 via a wired connection, e.g., a USB connection between user device 110 and contextualization system 115. In some embodiments, network 140 may connect one or more aspects of environment 100 via an electronic network connection, for example a wide area network (WAN), a local area network (LAN), personal area network (PAN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted and/or operated by a computer system so as to be accessible online, and that may include data configured to cause a program such as a web browser to perform operations such as send, receive, or process data, generate a visual display, e.g., a window, and/or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, all or a portion of authentication system 120 may be integrated into contextualization system 115 or the like. In another example, authentication system 120 and contextualization system 115 are distributed across one or more systems. In another example, authentication device 125 may be integrated in user device 110. In some embodiments, operations or aspects of one or more of the components discussed above may be distributed amongst one or more other components. Any suitable arrangement and/or integration of the various systems and devices of the environment 100 may be used.

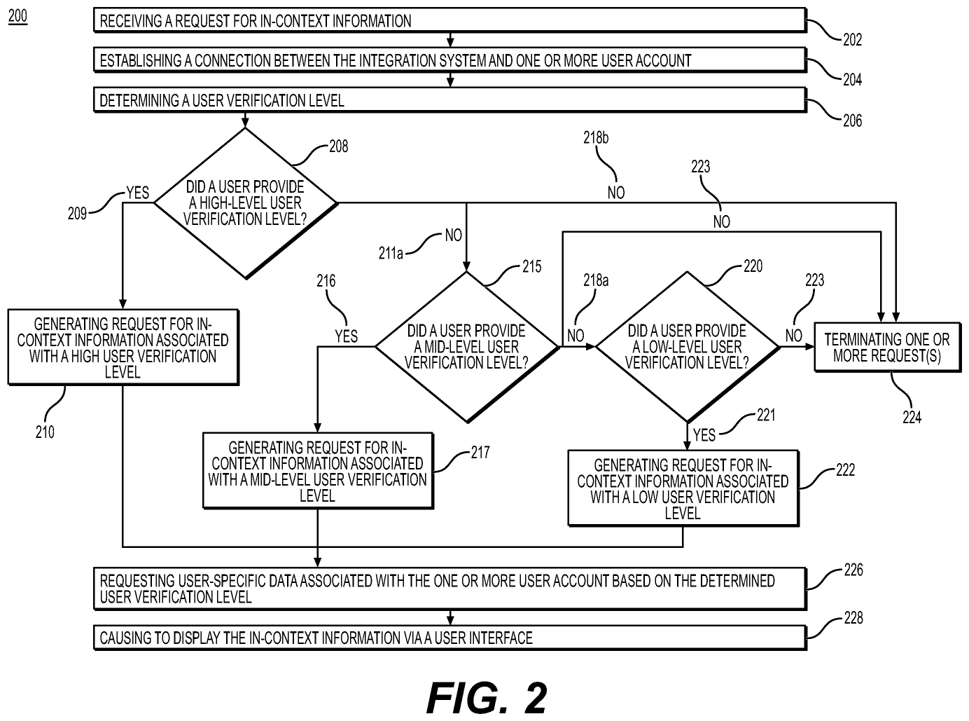

FIG. 2 depicts an exemplary method for providing in-context information, according to one or more embodiments. At step 202, an information request (e.g., a request for in-context information) may be received. As discussed herein, the request may be received by any suitable system, e.g., contextualization system 115 and/or authentication system 120, and from any suitable system, e.g., user device 110.

The request may be generated in response to a trigger event, e.g., a user input from user 105 at GUI 111. The user input may be in any suitable form, such as a cursor click, a cursor hover, focus on an area, viewing a product page, viewing a stock-keeping unit (SKU) page, adding an item to a virtual shopping cart, selecting an item, initiating a webpage, downloading a browser plug-in, initiating a browser plug-in, etc. For example, as depicted in FIG. 3A, browser 300 may display an information page 301, which may include one or more of a browser plug-in icon 305, a virtual shopping cart icon 310, and/or an Add-to-Cart icon 315. As depicted in FIG. 3B, a cursor 327 may hover over Add-to-Cart icon 315. Cursor 327 hovering over Add-to-Cart icon 315 may be the trigger event that generates the information request in this example. As further described below, the in-context information may be obtained and displayed as depicted by browser 325 displaying context panel 330 in FIG. 3B, which may be generated by a browser plug-in. As described herein, context panel 330 may be a user-specific information window populated at least with user-specific data.

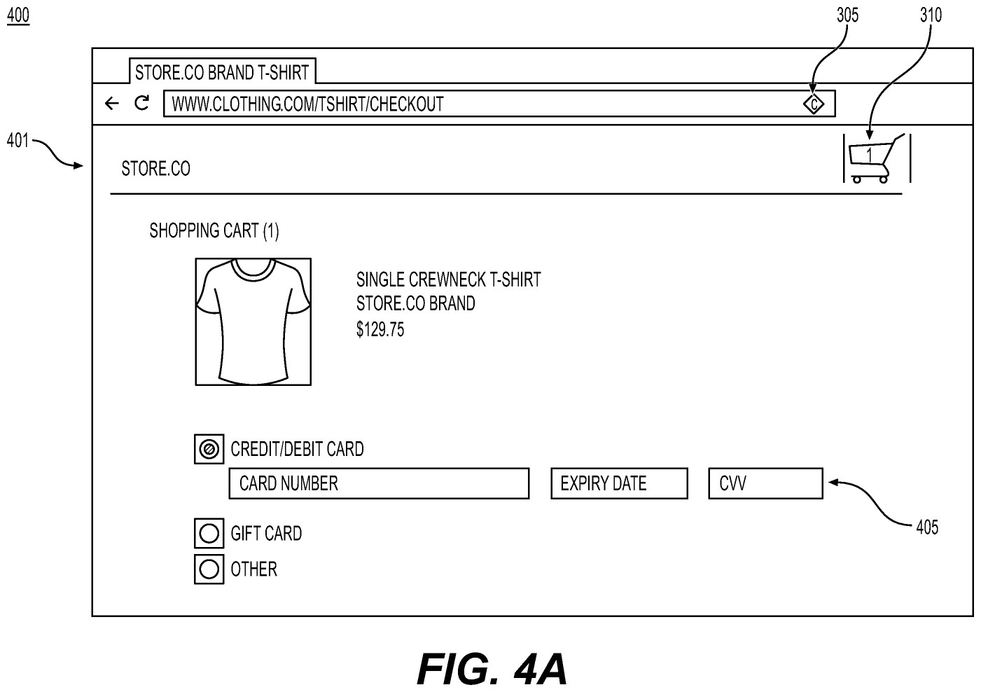

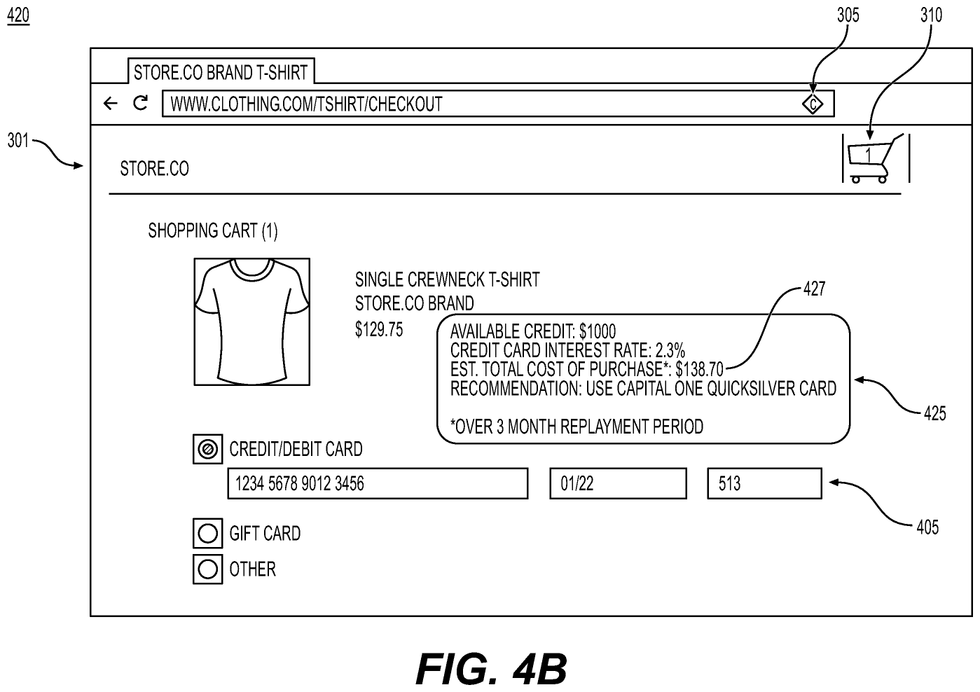

In another example, as depicted by browser 400 of FIG. 4A, a virtual shopping cart 401 may include one or more of browser plug-in icon 305, virtual shopping cart icon 310, and/or a payment space 405. It should be understood that, in some embodiments, virtual shopping cart icon 310 may display data, such as the number of items in virtual shopping cart 401. As shown by browser 420 of FIG. 4B, data entered into the payment space 405 may be the trigger event that may cause the information request to be generated. As depicted in FIG. 4B and further described below, the in-context information may be obtained and displayed on a webpage as depicted by context embedding 425, which may be generated and/or modified by an API, e.g., using JavaScript.

The type, form, sensitivity, etc. of the in-context information requested by the information request may depend on the type of user input, the location of the user input, repetition of the user input, etc. For example, a purchase recommendation may be the sole information displayed in response to cursor 327 hovering over Add-to-Cart icon 315. In another example, any or all of a user's available credit, a user's credit card interest rate, an estimated total cost of a purchase, and/or a purchase recommendation may be displayed in response to cursor 327 clicking on browser plug-in icon 305. As described in further detail below, the information displayed in response to one or more user inputs may be customized. It should be noted that the above examples are intended to be non-limiting, and any combination of user input, in-context information, display, etc. is contemplated.

Returning to FIG. 2, at step 204, a connection between an integration system, e.g., contextualization system 115, and one or more user accounts 117 may be established. The connection may be any suitable format, such as a network connection, as discussed herein. Further, as discussed herein, any suitable system may be configured to operate as the integration system, e.g., contextualization system 115, authentication system 120, combinations thereof, etc.

At step 206, method 200 may determine a user verification level. As discussed herein, the user verification level may be determined in response to receiving a verification request, e.g., at authentication system 120. As also discussed herein, the user verification level may be determined by any suitable system or combination of systems, such as one or both of contextualization system 115 or authentication system 120.

The user authentication level may be determined by any suitable method or in any combination of methods, e.g., a numerical value, a points system, a ranking system, a decision tree, etc. In some embodiments, the user authentication level may be ranked as high-level authentication (step 208: yes), mid-level authentication (step 208: no followed by step 215: yes), or low-level authentication (step 208: no, followed by step 215: yes, followed by step 220: yes) based on the authentication method used. For example, a high-level authentication (step 209) may be achieved by the use of multi-factor authentication, a mid-level authentication (step 216) may be achieved by the use of a single-factor authentication, or a low-level authentication (step 221) may be achieved by the use of a log-in authentication.

It should be noted that any suitable authentication method or combination of authentication methods may be used, e.g., single-factor, two-factor, or multi-factor authentication, log-in authentication, self-service password reset authentication, token authentication, API authentication (e.g., embedded API authentication), etc. Any authentication method may correspond to any authentication level. In some embodiments, user 105 may determine the relationship between the authentication level and the authentication method, e.g., by customizing the display, as discussed in further detail below.

For example, as depicted in FIG. 3C, browser 350 may display an authentication window 355. Authentication window 355 may display an authentication method, e.g., a log-in request 357, which may be the first factor of authentication for high-level authentication which, when successfully completed, may cause to be generated a second authentication factor. The second authentication factor, as depicted in FIG. 3D, may be any suitable authentication factor e.g., a push notification 375, and may be displayed via any suitable device, e.g., via GUI 372 displayed by cell phone 370, or any suitable aspect of environment 100, e.g., GUI 111 displayed by user device 110 or GUI 127 displayed by authentication device 125. In another example, log-in request 357 may be the sole factor of authentication for low-level authentication. In another example, successful completion of both log-in request 357 and push notification 375 may result in a high-level authentication, and successful completion of log-in request 357 but failure to complete push notification 375 may result in a low-level authentication. User 105 may manually determine the relationship between the authentication factor and authentication level, or the relationship may be pre-determined by an aspect of environment 100, e.g., by authentication system 120.

Authentication at one or more levels may cause a request for in-context information associated with that level to be generated. In some embodiments, the type, form, content, amount, etc. of in-context information requested may depend on the authentication level achieved. For example, if a high-level authentication is achieved, method 200 at step 210 may generate a request for in-context information associated with a high authentication level. In some embodiments, in-context information associated with a high authentication level may include amount of money in one or more accounts (e.g., in debit accounts), available credit, total debt across all of a user's credit cards, a user's past payment history, how much total interest may be paid on a total account balance after a purchase based on certain variables, interactions with a given retailer (e.g., prior transactions with the retailer, prior returns to the retailer, etc.), interactions with similar classes of retailers (e.g., transactions with clothing retailers, grocery retailers, food retailers, etc.), recommendations (e.g., lifestyle recommendations) based on the in-context information associated with a high authentication, etc.

In another example, if a mid-level authentication (step 216) is achieved, method 200 at step 217 may generate a request for in-context information associated with a mid-level authentication. In some embodiments, in-context information associated with a mid-level authentication may include how long a purchase may take to pay off based on certain variables, how much total interest may be paid on a purchase based on certain variables, etc.

In another example, if a low-level authentication (step 221) is achieved, method 200 at step 222 may generate a request for in-context information associated with a low authentication level. In some embodiments, in-context information associated with a low authentication level may include publicly available information, e.g., credit card interest rates, benefits associated with a credit and/or debit card, etc. In some embodiments, failure to achieve any authentication level may result in method 200 requesting in-context information associated with user accounts, e.g., one or more user accounts 117, and/or with no verification requirement. In some embodiments, in-context information associated with no required authentication level may include publicly available information, e.g., credit card interest rates, benefits associated with a credit and/or debit card, etc.

In some embodiments, failure to authenticate at one or more levels may result in a request for a further authentication (e.g., at the same level), a second authentication method (e.g., at a lower authentication level), or a termination and/or rejection of one or more of the requests, e.g., the information request, the verification request, and/or the authentication request. For example, failure to achieve high-level authentication may result in a request for mid-level authentication (step 211a) or termination of one or more of the requests (steps 211b, 224). In another example, failure to achieve mid-level authentication may result in a request for low-level authentication (step 218a) or termination of one or more of the requests (steps 218b, 224). In another example, failure to achieve low-level authentication may result in termination of one or more of the requests (steps 223, 224). As described in more detail below, in some embodiments, failure to achieve a particular level of authentication or any level of authentication may result in the display of information associated with no authentication level, e.g., publicly available interest rate data.

In some embodiments, failure to authenticate may result in a repeated authentication request. For example, failure to authenticate at a mid-level, e.g., using a log-in authentication method, may result in the system sending a further authentication request for a mid-level authentication, e.g., using a log-in authentication method.

At step 226, method 200 may request in-context information (e.g., user-specific data) associated with the one or more accounts, e.g., the one or more user accounts 117. As discussed herein, the one or more user accounts 117 may include any one or more of a checking account, a savings account, a credit account, a credit score account, a financial profile, etc. The user-specific data may include one or more of an account balance, an estimated payoff time, an interest rate associated with an account, an estimated amount of interest to be paid based on a purchase, an estimated amount of interest to be paid based on the account balance, etc. The user-specific data, e.g., in-context information, may be requested and/or retrieved from any one or more of: one or more aspects of environment 100, one or more storage systems (e.g., database 130), one or more third party systems, etc. As discussed above, the requested user-specific data may be based on the user verification level determined. For example, in some embodiments, higher authentication levels may be required in order to obtain more sensitive data. The level of sensitivity of the user-specific data may be determined manually, e.g., by user 105, or automatically, e.g., by contextualization system 115.

At step 228, method 200 may cause the requested in-context information to be displayed. For example, context panel 330 may be populated with in-context information 332. The in-context information may be displayed by a user interface, e.g., via GUI 111. The in-context information displayed (in-context information 332) may be based on the user verification level determined as described above. Any combination of in-context information associated with high-level, mid-level, low-level, and/or no authentication may be displayed. For example, as depicted in FIG. 3B, in-context information associated with a high authentication level (e.g., current credit availability and/or recommendation), in-context information associated with a mid-level authentication (e.g., current credit card interest rate), and/or in-context information associated with a low authentication level (e.g., estimated total cost of purchase over three months based on an industry average credit card interest rate) may be displayed via context panel 330.

The manner in which the in-context information is displayed may depend on the method of integration (e.g., browser plug-in, API, or embedded browser). For example, as depicted in FIG. 3B, a browser plug-in integration system may generate an information window, e.g., context panel 330, to display in-context information 332. In another example, as depicted by FIG. 4B, an API may generate an embedded context window (e.g., context embedding 425) to display in-context information, e.g., in-context information 427. Any suitable method may be used to generate the embedded context window, such as JavaScript.

In some embodiments, the data displayed may be customized. In some embodiments, context panel 330 may include a customization icon 335 that may be used to generate a request to customize at least part of context panel 330 and/or the display of in-context information 332. For example, user 105 may customize context panel 330 to display the top three best rewards offers for three respective credit cards for a given purchase. As discussed herein, this customization may determine the relationship between the authentication method and the authentication level, the in-context information displayed (e.g., at corresponding authentication levels), the way the in-context information is displayed, etc.

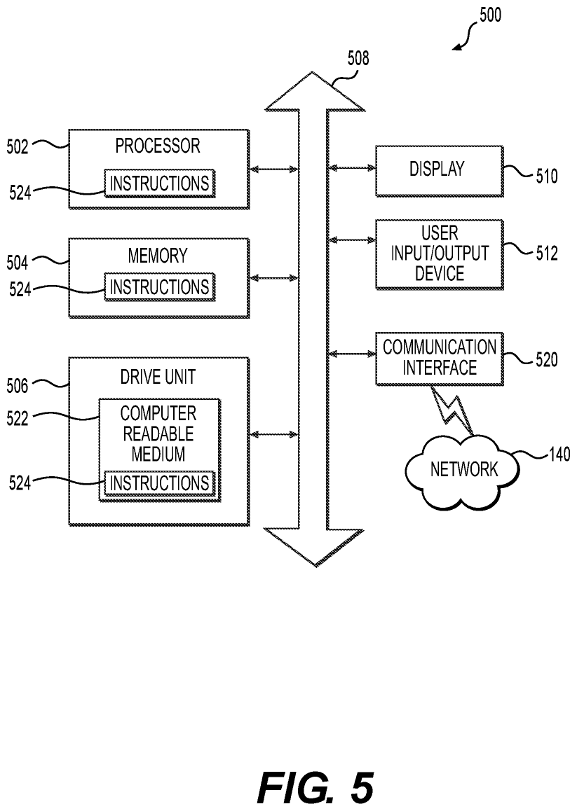

FIG. 5 depicts a simplified functional block diagram of a computer 500 that may be configured as a device for executing the methods disclosed here, according to exemplary embodiments of the present disclosure. For example, the computer 500 may be configured as a system according to exemplary embodiments of this disclosure. In various embodiments, any of the systems herein may be a computer 500 including, for example, a data communication interface 520 for packet data communication. The computer 500 also may include a central processing unit (CPU) 502, in the form of one or more processors, for executing program instructions. The computer 500 may include an internal communication bus 508, and a storage unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 may be stored temporarily or permanently within other modules of computer 500 (e.g., processor 502 and/or computer readable medium 522). The computer 500 also may include input and output ports 512 and/or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for providing in-context information, the method comprising:
receiving a request for the in-context information, the request generated by an integration system in response to a trigger event at a user interface, wherein:
the trigger event is any of a selection made by a user via an input device, a focus area selected by the user via the input device, or initiation of a web browser;
the in-context information includes user-specific data;
establishing a connection between the integration system and one or more user accounts;
determining a user verification level, wherein the user verification level is determined using one or more authentication methods;
upon determining the user verification level, requesting the user-specific data associated with the one or more user accounts, the requested user-specific data indicative of the determined user verification level; and
causing to display the in-context information via the user interface, the displayed in-context information determined based on the determined user verification level.

2. The method of claim 1, wherein the integration system is any of an application programming interface (API), a web browser plug-in, or an embedded browser.

3. The method of claim 1, wherein the user-specific data includes any of an account balance, an estimated payoff time, an interest rate associated with an account, an estimated amount of interest to be paid based on a purchase, or an estimated amount of interest to be paid based on the account balance.

4. The method of claim 1, wherein the user verification level is determined based on the one or more authentication methods used.

5. The method of claim 1, wherein the user-specific data associated with the one or more user accounts includes one or more of prior user purchases from a retailer, prior user returns from the retailer, or other user transactions with the retailer.

6. The method of claim 5, further comprising:
providing one or more recommendations for the user based on the user-specific data associated with the one or more user accounts; and
causing to display the one or more recommendations via the user interface.

7. The method of claim 6, wherein the one or more recommendations include using a particular bank card or lifestyle suggestions.

8. The method of claim 1, wherein the causing to display the in-context information via the user interface includes modifying the user interface using JavaScript to display the in-context information on a webpage.

9. The method of claim 1, further comprising:
generating a user-specific information window, the user-specific information window populated with at least the user-specific data; and
causing to display the user-specific data via the user-specific information window.

10. The method of claim 9, further comprising:
modifying one or more aspects of the user-specific information window via the user interface.

11. A method for providing in-context information, the method comprising:
receiving a request for the in-context information, the request generated by an integration system in response to a trigger event at a user interface;
establishing a connection between the integration system and one or more user accounts;
determining a user verification level, wherein the user verification level is determined using one or more authentication methods;
upon determining the user verification level, requesting user-specific data associated with the one or more user accounts, the requested user-specific data indicative of the determined user verification level; and
causing to display the in-context information via the user interface, the displayed in-context information determined based on the determined user verification level.

12. The method of claim 11, wherein the in-context information includes any of an account balance, an estimated payoff time, an interest rate associated with an account, an estimated amount of interest to be paid based on a purchase, or an estimated amount of interest to be paid based on the account balance.

13. The method of claim 11, wherein the integration system is any of an API, a web browser plug-in, or an embedded browser.

14. The method of claim 11, wherein the trigger event is any of a selection made by a user via an input device, a focus area selected by the user via the input device, or initiation of a web browser.

15. The method of claim 11, wherein the user verification level is determined based on the one or more authentication methods used.

16. The method of claim 11, wherein the user-specific data associated with the one or more user accounts includes one or more of prior user purchases from a retailer, prior user returns from the retailer, or other user transactions with the retailer.

17. The method of claim 16, further comprising:
providing one or more recommendations for a user based on the user-specific data associated with the one or more user accounts; and
causing to display the one or more recommendations via the user interface.

18. The method of claim 17, wherein the one or more recommendations include using a particular bank card or lifestyle suggestions.

19. The method of claim 11, further comprising:
generating a user-specific information window, the user-specific information window comprising at least user-specific data; and
causing to display the user-specific data via the user-specific information window.

20. A system, the system comprising:
at least one memory storing instructions; and
at least one processor executing the instructions to perform operations for providing in-context information, the operations including:
receiving a request for the in-context information, the request generated by an integration system in response to a trigger event at a user interface, wherein:
the trigger event is any of a selection made by a user via an input device, a focus area selected by a user via an input device, or initiation of a web browser;
the in-context information includes user-specific data;
establishing a connection between the integration system and one or more user accounts;
determining a user verification level, wherein the user verification level is determined using one or more authentication methods;
upon determining the user verification level, requesting data associated with the one or more user accounts, the requested data indicative of the determined user verification level; and
causing to display the in-context information via a user interface, the displayed in-context information determined based on the determined user verification level.
